(19) United States
(12) Patent Application Publication
(10) Pub. No.: US 2013/0043788 A1
(43) Pub. Date: Feb. 21, 2013

(54) CONTROLLABLE VERSATILE LED SYSTEM

(71) Applicant: JOHN N. O'BRIEN, ST. AUGUSTINE, FL (US)

(72) Inventor: JOHN N. O'BRIEN, ST. AUGUSTINE, FL (US)

(21) Appl. No.: 13/658,403

(22) Filed: Oct. 23, 2012

Related U.S. Application Data
(63) Continuation-in-part of application No. 13/423,590, filed on Mar. 19, 2012.
(60) Provisional application No. 61/453,788, filed on Mar. 17, 2011.

(51) Int. Cl. H05B 37/00; H05B 37/02

(52) U.S. Cl. 315/112; 315/200 R; 315/291; 315/294; 315/360

(57) ABSTRACT

The present invention relates to the development of a method and system for manufacturing and deploying light emitting diode (“LED”) technology in a highly efficient manner. Devices of the invention include a printed circuit board with a heat sink and at least one LED insertion site and optionally a wireless communication device to control operation of the LED.

### CROSS-REFERENCE TO RELATED APPLICATION

This application is a continuation-in-part of U.S. application Ser. No. 13/423,590, filed on Mar. 19, 2012, which claims the benefit of U.S. Provisional Application Serial No. 61/453,788, filed Mar. 17, 2011, the contents of both of which are hereby incorporated by reference herein in their entirety.

### FIELD OF THE INVENTION

The present invention relates to light emitting diode (LED) devices, particularly to multi-function LED devices.

### BACKGROUND

Fluorescent lights are ubiquitous in commercial and institutional settings and are making significant in-roads into home use. The popularity of fluorescent lights is attributable, in-part, to their energy efficiency as compared to traditional incandescent lights. However, like incandescent light bulbs, fluorescent light bulbs have a limited life-span.

For example, many fluorescent light bulbs include a filament coated with an emission mix, typically barium or calcium oxide, that provides a source of electrons that excite mercury vapor in the bulb. This emission mix is sputtered off of the filament during normal use of the bulb, which eventually leads to failure. Other sources of failure include loss of the mercury vapor in the bulb or dimming of the phosphor that coats the inside surface of the bulb. In modern compact fluorescent lights, a ballast is provided as part of each bulb, which means that when the ballast electronics fail, the bulb must be discarded. In the aggregate, fluorescents lights tend to exhibit characteristic failure profiles just as incandescent light bulbs or other old technologies.

Since fluorescent light bulbs are known to fail after a limited amount of time, they are marketed and consumed as disposable, single-purpose items. Despite their efficiency gains relative to incandescent bulbs, fluorescent and incandescent bulbs are typically used in an essentially similar fashion. They are purchased with the knowledge that they will burn out before long and need to be replaced and thus are expected only to light up when turned on and go dark when turned off.

### SUMMARY

The invention provides versatile lighting devices that take the place of known light bulbs and provide control over many aspects of their operation. Lights of the invention can include on-board control elements such as remote-control receivers, timers, brightness controllers, and programmable logic controllers. Moreover, on-board circuitry can include a rectifier, transformer, other circuit elements, or a combination thereof that make the light competent for operation in many diverse fixtures, circuits, or power grids. Illumination is provided by one or more LED, operatively coupled to any control element or circuit element via a printed circuit board. Since LEDs have operating lifetimes as high as 200,000 hours, lighting devices of the invention are long-lived. Accordingly, one insight of the invention is that light devices no longer need be thought of as disposable, single-purpose items. Thus the invention provides a simple but long-lived light device that can include robust network controllable functionalization and that can be deployed in multi-unit installations (e.g., whole house or whole campus) to interact with one another or to be under common control. Since individual lighting devices of the invention include one or more LED on a printed circuit board (PCB) as well as any optional combination of heat sink, rectifier, dimmer, timer, remote-control device, or master-slave setting switch, lighting at a facility can be planned for central control or systematic control. Light of the invention can be used in regions with different power grids or power supplies. Also, since individual light devices can be purchased and used without the limiting assumption that they are a short-lived, simple binary device, complex centralized lighting installations can be planned that depend on remote operability or complex functionality of the individual devices.

Devices of the invention may be used to retrofit an existing lighting application or for new fixtures for indoor lighting, outdoor lighting such as common areas and parking lots, marine lighting, off-grid power and lighting, security systems, multimedia applications, photography, religious lighting, medical or therapeutic applications, outreach and disaster applications, among others. Many environments are not connected to any integrated electric grid system. In fact more than two thirds of the world's population are not connected to an electric grid and are, therefore, “off-grid”. The invention can be used in an integrated or non-integrated manner to provide light and power to off-grid areas.

In certain aspects, the invention provides a printed circuit board with insertion sites for LEDs and an optional heat sink to dissipate heat that is generated by the LEDs once illuminated. The heat sink can be highly polished and used as a reflector in and solar energy applications. The printed circuit board may be ridged, flexible, static, dynamic and configured in various ways to accommodate the LEDs and the external heat sink so that the LEDs can generate light and the overall temperature of the system does not rise to the point that the system can be damaged by the heat generated by the LEDs. The printed circuit board may be configured in strips or sticks, rectangular, trapezoidal, circular, sphere, cylindrical, or other shape and may have length/width or radial dimensions between about a few millimeters and several meters. The system may contain an integrated driver (i.e., transformer/power supply) which converts alternating current electric supply into direct current suitable to power LEDs. The system can also be operated on a DC battery, solar panels, fuel cells or other power sources. Several types of drivers may be employed in different configurations. The LEDs may be configured into various circuits including in series or parallel. In addition, the strips, sticks or other shapes may be coupled with fixtures so that they can be interconnected directly without the use of wires or may be subject to a wiring harness.

In certain aspects, the invention provides a lighting device that includes a printed circuit board with a rectifier coupled to the circuit board and an insertion site on the circuit board for an LED. An LED may be provided in the insertion site to provide light. The device may have a form factor to be installed into a standard light fixture, such as a fluorescent light bulb form factor. The circuit board may further include a heat sink, a dimmer, a timer, a receiver for remote control instructions, a settable master/slave setting, a receiver to receive wireless control signals to control operation of the LED, or a combination thereof.

In related aspects, the invention provides a lighting device having a printed circuit board with an insertion site for an LED and a dimmer coupled to the circuit board. The device may further include a heat sink, an LED in the insertion site, a fluorescent light bulb form factor, a rectifier, a timer, a receiver for remote control instructions, a settable master/slave setting, or a combination thereof.

In other related aspects, the invention provides a lighting device that has a printed circuit board with an insertion site for an LED and a timer coupled to the circuit board to control timing of the operation of an LED.

In other aspects, the invention provides a lighting device that has a printed circuit board with an insertion site for an LED and a receiver for remote control instructions coupled to the circuit board. The receiver may operate by known principles such as Wi-Fi, infrared, cellular RF signals, or power line communication and may include the appropriate antenna or device. In some embodiments, the receiver is a transceiver and the lighting device includes a master/slave switch. One of the devices can be provided such that, if the master/slave switch is in the slave setting, the device is operable to receive instructions from another lighting device and cause the LED to operate according to the instructions. Such a lighting device of the invention may further include a microprocessor configured to, if the master/slave switch is in the master setting, transmit control signals via the transceiver.

In certain embodiments, the receiver is a power line communication device such as, for example, a signal modulator, demodulator, or modem. The power line communication device may operate by pulse-width modulation or by the X10 industry standard. Where power line communication is employed, devices and systems of the invention provide control over individual and entire systems of LED devices using the in-building or area-wide power grid to carry control signals. Individual devices may communicate via a central hub, which may be a master-device (e.g., one of the same LED devices, with a master-slave setting switch in the master setting), a computer, or a control box (e.g., a dedicated piece of hardware with a controller such as a field programmable gate array).

In some embodiments, each individual device is provided with a unique number, such as a serial number. The unique number may be hard coded in on-chip read-only memory, may be added via a radio-frequency identification tag, or may be assigned and stored, for example, when a deployment first goes online. In certain embodiments, each fixture is assigned a unique number (e.g., on-chip or via RFID tag). A communication hub may recognize each device by device number or by combined fixture-device number. For example, a central computer may recognize that 12345678 is the fixture in the entryway, and when a new LED device is installed in that device with unique number 876554321, the central computer may determine that device 87654321 is the entry way lamp and needs to be monitored and controlled according to program standards for the entryway lamp.

In other aspects, the invention provides a system for lighting space that includes a plurality of lighting devices, each comprising an LED and a transceiver operably coupled to a printed circuit board. The system further includes a computing device, with a processor coupled to a storage device, that can be used to send control signals that are then received by, and control the operation of, the lighting devices. In some embodiments, the computing device communicates with the lighting devices through the use of a communication technology such as, for example, Wi-Fi, cellular RF, power line communication, or infrared. The computing device may further include a computer program application which a user can pre-program so as to operate the lighting devices. Using the computing device, the system can control the lighting devices by turning them on and off, controlling brightness, and setting a schedule for these events. In some embodiments, the system will include a rectifier to modulate current received by one or any of the lighting devices or the computer device. The lighting devices can include a heat sink. The lighting devices may be provided in a light-bulb form factor for retrofitting into existing fixtures (e.g., with a fluorescent bulb form factor). In certain embodiments, one of the lighting devices operates in a master setting and others of the devices operate in a slave setting, such that each slave lighting device receives the signals from the master lighting device.

In other aspects, the invention provides a method of changing illumination of a space by using an electronic device to transmit a signal to a lighting device, the lighting device comprising an LED and a receiver coupled to a printed circuit board. Methods include receiving the signal with the receiver and changing an amount of light emitted from the LED based on data in the signal.

In some embodiments, the electronic device is a master lighting device itself including an LED, a controller, and a transmitter operably coupled to a master circuit board and configured to send the signal to the lighting device. The lighting device (or a number of them, where a plurality are used) can receive signals via a communication technology by, for example, having the receiver be a Wi-Fi device, a power line communication device, a cellular RF device, or an infrared device.

In certain embodiments, the electronic device is a computer device with a tangible, non-transitory memory and an input/output device coupled to a processor operable to transmit the signals according to a set of computer program instructions. For example, the electronic device can be provided by a desktop computer, laptop computer, tablet computer, or a smartphone.

A rectifier can be included coupled to the circuit board of the lighting device (or on the circuit boards of any number of the lighting devices, where a plurality are included). Changing the illumination can include brightening or dimming (gradual or stepwise), turning on or off (at will or according to a program), or a combination thereof. Light levels can be controlled by controlling amperage, using a potentiometer, or using pulse width modulation.

Methods of the invention can be used to control a plurality of lighting devices such as, for example, a number of lights distributed among a plurality of buildings on a campus, throughout a hospital, or among a number of buildings in a chain of stores.

In certain embodiments, the electronic device can include a computer workstation (e.g., in a control center) and have, for example, a monitor and keyboard. The lights can be operated or monitored at will or in a pre-programmed manner.

### DETAILS OF THE INVENTION

Embodiments of the invention provide a lighting device that includes a printed circuit board with an insertion site for an led. The printed circuit board may have a length or a width between a few millimeters and a few meters (or any dimension may be between about 1 nanometer and 100 meters). The circuit board may include one or multiple sites to insert LEDs, such as 2, 3, 4, 5, 6, 7, 8, 9, 10, 12, 15, 16, 25, 32, 36, 48, 49, 50, 64, 75, 100, 121, 128, 144, 200, 256, 512, >100s, >1,000s etc. In some embodiments, the printed circuit board includes etched copper sheets laminated onto a non-conductive substrate.

The lighting device may have any suitable form-factor, both overall, and as to the connection point at which it is mounted into a fixture. For example, a printed circuit board may be housed in a glass, plastic, or polymer case with external contact terminals to which the internal circuit board is conductively connected. The lighting device may have a traditional bulb form factor with a screw-in connector at the base, or a fluorescent bulb form factor with pin connectors at each end, or any other suitable bulb-replacement form factor. LED devices with bulb-like form factors are discussed in U.S. Pub. 2012/0068604; U.S. Pub. 2011/0121756; U.S. Pub. 2010/0315001; and U.S. Pub. 2010/0188001, the contents of each of which are incorporated by reference in their entirety for all purposes.

The lighting device may include one or more of the printed circuit boards and the printed circuit boards may be shaped into strips, sticks, or other shapes. The lighting device may be used to replace fluorescent bulbs, incandescent bulbs, metal halide bulbs, ballasts, induction lighting, and any other type of lighting technology. Incandescent replacements and circuits are discussed in U.S. Pub. 2008/0130288, the contents of which are hereby incorporated by reference in their entirety. The strips, sticks or other shapes may be aligned in a linear fashion or side-by-side depending on the application. Strip structures are described in U.S. Pat. No. 5,848,837, the contents of which are hereby incorporated by reference in their entirety.

The lighting device, the printed circuit board, or both may also have the capability to emit light from both sides, from one side, or may be omni-directional. It may be used for decorative purposes, signage lighting, emergency lighting, street lighting, garage lighting, clothing applications (e.g., for safety personnel such as uniforms and finger lights) and other applications (see, e.g., U.S. Pub. 2006/0035511, the contents of which are hereby incorporated by reference in their entirety for all purposes). It may also include embedded or external optical adjustments or filters. The strips, sticks or other shapes may also be canted on angles to enhance light dispersion. The strips or sticks may also be equipped with magnets to affix the strips into a fixture or may utilize a fixative such as glue, paste, vacuums, or other means.

In certain aspects, the invention provides a lighting apparatus that includes a printed circuit board, a heat sink, and at least one LED, in which the lighting apparatus has a form factor to replace a fluorescent light bulb and includes one or more bi pin connection. The printed circuit board may include resistors or other known circuit elements. In certain embodiments, the printed circuit board further includes circuitry to balance power demands so that the lighting apparatus can be used within a standard fluorescent fixture (e.g., T2, T4, T5, T8, T9, T10, T12, T17, PG17, with straight, bent, or circular shape) with or without bypassing the ballast. Thus a user may obtain one or more lighting apparatus of the invention and replace an existing fluorescent bulb with no modification of existing hardware.

The invention provides methods and systems for controlling the rectification of the current. In some embodiments, a lighting device includes a rectifier, for example, operably coupled to the printed circuit board. Rectification is a means for keeping the current that goes to the LEDs at the desired amperage regardless of the source of the power. Through the use of a rectifier, the circuit on the circuit board may be a constant current source, which means that it keeps the LED brightness constant no matter what power supply is used or surrounding environmental conditions one subjects the LEDs to. Rectification of the current may be done by a circuit printed on the circuit board that uses, for example, resistors, small NPN transistors, large N-channel FET or other devices as needed depending upon the overall design of the circuit board. By not using constant current drivers, the expense on drivers for the overall system is significantly decreased. Rectifiers for LED systems are discussed in U.S. Pat. No. 7,507,001; U.S. Pat. No. 7,049,761; U.S. Pat. No. 6,936,968; U.S. Pat. No. 6,853,151; U.S. Pub. 2012/0161666; and U.S. Pub. 2007/0223225, the contents of each of which are incorporated by reference in their entirety for all purposes. In various embodiments, the printed circuit board may contain an integrated driver mounted thereon, an external driver, or both. Circuitry on the printed circuit board can be used in control of operation of the one or more LEDs. For example, a driver circuit can be included to use current feedback to adjust power to LEDs in arrays and provide full light and dim mode. Circuits suitable for use with the invention are discussed in U.S. Pat. No. 7,791,285; U.S. Pat. No. 7,116,294; U.S. Pat. No. 6,836,081; U.S. Pat. No. 6,589,890; and U.S. Pub. 2006/0221606, the contents of each of which are incorporated by reference herein in their entirety for all purposes. The driver can be used for dimming or setting lighting levels as appropriate including microcontrollers, self-reliant circuitry and other processing functions.

A lighting device of the invention can include a mechanism for heat management. For example, the printed circuit board may optionally be coupled to a heat sink to dissipate heat. In certain embodiments, a heat sink includes a block of metal, such as aluminum, with a finned surface and optionally a fan. The heat sink may be passive in nature, configured with fins to dissipate heat or may utilize an integrated fan or other air moving device. Heat sinks with LEDs are discussed in U.S. Pat. No. 8,123,378; U.S. Pub. 2010/0144648; U.S. Pub. 2009/0116252; and U.S. Pub. 2004/0264195, the contents of which are hereby incorporated by reference in their entirety. In certain embodiments, the one or more LEDs are each mounted to a material that is dimensioned to operate for heat management. For example, a thin LED is discussed in U.S. Pub. 2008/0151543, the contents of which are hereby incorporated by reference in their entirety.

Lighting devices of the invention can include features or combinations of features to provide enhanced functionality. In certain embodiments, the lighting device includes one or more of a printed circuit board, a heat sink, an LED, a resistor, a communication device, or combination thereof operably connected to detect or control a present state of the apparatus and communicate over a network with a computer. The printed circuit board may optionally include any combination of rheostat; diode; PIN diode; photovoltaic cell; fan; motor; infrared detector or transmitter; power line modem; RF antenna; switch; processor; digital camera or video camera; chime; memory (e.g., flash memory chip or connected hard drive); bus or connections; data connector (e.g., RJ 45 jack); battery; motor; power connection; connections to other printed circuit boards; or non-LED (e.g., incandescent) light receptacle. A computer generally includes a memory, processor, and input/output device, connected by a bus. Exemplary input/output devices include keyboard, pointer (e.g., mouse or trackpad), and Wi-Fi card; touchscreen and Wi-Fi card or cellular RF antenna; Ethernet jack (e.g., for 10/100 network communication via an RJ45 connection); USB port; USB port with internet via USB adapter device; or any combination of the foregoing. Exemplary computers include laptops, desktop PCs or Macs, tablets and smart phones.

An illumination state of an LED, such as on-off or brightness, may be controlled via control elements either proximally (e.g., timer on the circuit board), distally (e.g., via a receiver on the circuit board), or through a combination thereof. Control of the illumination state allows for at-will or pre-programmed control, including remote control, of operation (on/off), timing (e.g., according to a schedule), and even brightening or dimming (e.g., either gradually or stepwise).

In certain embodiments, a lighting device includes a dimmer. The dimming (or brightening) of the LEDs may be accomplished through reducing (or increasing) the amperage that is being delivered to the LEDs. As the amperage decreases, the light output of the LEDs also decreases. The decrease in amperage can be accomplished using a potentiometer or through pulse width modulation, among other methods. The amperage in the circuit may be controlled by a combination of precision internal reference voltage and an external input to the circuit. The dimming may be accomplished in a continuous manner from bright to off or stepwise. For instance the LEDs may be operated at high, medium, and low brightness rather than in a continuous manner. There are many circuit designs which can be incorporated into the circuit board to accomplish this objective. In certain embodiments, the apparatus includes a rheostat or similar controller to control a brightness or state of an LED.

Lighting devices of the invention may further include timer controllers. There are numerous circuit designs for timing devices that can be integrated into the printed circuit board. The timing device can be programmable such that it can set the brightness of the LEDs according to certain times of day and/or days of a week. Timers for control of LEDs are discussed in U.S. Pat. No. 7,507,001; U.S. Pat. No. 5,253,228; and U.S. Pub. 2005/0180137, the contents of each of which are incorporated by reference herein in their entirety.

In certain embodiments, the invention provides LED lights with remote-control capability. An illumination state of an LED on a printed circuit board can be changed according to instruction received at the printed circuit board via a receiver. The remote control instructions can be transmitted from a handheld remote, from a computer device, or from another LED-based lighting device. Instructions may travel wirelessly (e.g., Wi-Fi, cellular RF, or infrared), over the power supply wires, via dedicated wires, or a combination thereof. Remote control instructions may be received from a transmitter directly (e.g., in the case of point-to-point infrared transmission from a hand-held remote to an LED lighting device) or indirectly. An example of indirect remote control includes operating one or a plurality of LED lights from a computer program, with the instructions transmitted over the Internet, a cellular network, Wi-Fi, wires, or a combination thereof. The receiver on a printed circuit board can be an infrared sensor, a Wi-Fi antenna, a power line signal modem, or a cellular RF antenna. Moreover, the receiver may be a transceiver, and may also be used to transmit, or to relay, information such as instructions, to another LED lighting device or to a computer. Remote control instruction to lighting devices can be received and acted on in real time. For example, a user picks up a remote and hits the off button and the light goes off.

In certain embodiments, the invention provides a lighting device with Wi-Fi enabled communication capabilities. A Wi-Fi enabled lighting device can connect to the internet or to a local area network (LAN) using a wireless connection. Wireless connection of LED devices is discussed in U.S. Pat. No. 7,606,602; U.S. Pub. 2010/0271802; and U.S. Pub. 2010/0141153, the contents of which are hereby incorporated by reference in their entirety. A Wi-Fi enabled device such as a personal computer, video game console, smartphone, or digital audio player can connect to the Internet when within range of a wireless network connected to the Internet. The coverage of one or more (interconnected) access points—called hotspots when offering public access—generally comprises an area the size of a few rooms but may be expanded to cover many square miles, depending on the number of access points with overlapping coverage.

In certain embodiments, the invention provides a lighting device capable of being controlled via power line communication. The invention further provides methods and systems of controlling lighting in buildings and areas via power line communication. Power line communication involves modulating a current that is being used to deliver power to also carry a data signal. The signal can be read at a receiving device by demodulating the current. The current can thus be used to both power an LED, other on-chip devices, or a combination thereof as well as to control the operation of those elements. Any system of power line communication may be used. One suitable system is the X10 industry standard originally developed by Pico Electronics (Glenrothes, Scotland). Another suitable system is the Insteon system designed by SmartLabs, Inc. (Irvine, Calif.). Power line communication for LED is discussed in U.S. Pat. No. 7,925,239; U.S. Pat. No. 7,507,001; U.S. Pub. 2012/0133298; U.S. Pub. 2009/0323257; and U.S. Pub. 2009/0003832, the contents of which are hereby incorporated by reference in their entirety for all purposes. Power line communication is discussed in U.S. Pat. No. 7,245,212; U.S. Pat. No. 7,098,773; U.S. Pat. No. 6,377,163; U.S. Pat. No. 5,475,360; U.S. Pat. No. 5,264,823; U.S. Pat. No. 5,227,762; and U.S. Pub. 2011/0140902, the contents of each of which are incorporated by reference in their entirety.

In certain embodiments, the invention provides LED lighting devices capable of being operated in master/slave relationships in which, for example, a printed circuit board of one device in a fixture or a room may be designated as the master circuit board and the rest would be slaves that would perform the tasks the master circuit board is instructed to carry out. Each of the printed circuit boards would have the capability of being designated as the master circuit board. Any circuit boards not so designated would be set as a default to be slave circuit boards. The slave circuit boards would receive instructions from the master circuit board. In this manner the user will be able to control all of the LEDs in a fixture or in a room or in a building depending on the configuration of master circuit boards and slave circuit boards. Master/slave LEDs are discussed in U.S. Pat. No. 8,080,819; U.S. Pat. No. 7,507,001; U.S. Pub. 2006/0221606, the contents of which are incorporated by reference.

In some embodiments, circuitry within the apparatus detects a present failure state of the apparatus and communicates a present failure state over a network to a computer. An operator may receive information about a present state via a computer program, for example, through a web browser, custom program, shell prompt, or app. An apparatus can communicate a failure state via a network to a user (e.g., send signal from Wi-Fi card to household Wi-Fi hotspot, through internet connection to server operated by server provider company, retransmitted as data signal over 3G cell network and received at smartphone as information alert through program app). An apparatus can be configured to optionally turn on an alternative light source (e.g., backup incandescent light) responsive to a failure or receive program instructions from a user program to turn on an alternative light source.

In certain aspects, computer-control of lighting devices and systems is provided. In certain embodiments, the invention provides a computer program including instructions and stored on a tangible, non-transitory computer readable medium. In some embodiments, the computer program operates on a server computer that a user accesses via a local computer (e.g., laptop, desktop, tablet, or smartphone). For example, a user may log in to their account via a web browser to interact with the program and control the LED device or system. In certain embodiments, the computer program operates on the local computer.

A user interacts with the program to cause a computer system to execute program instructions causing the system to operate one or more LED device. Exemplary operations that can be initiated in an apparatus via a command include power on; power off; brighter; dimmer; override on-chip commands (e.g., emergency power on); bypass resistor; change resistance; logic operation (e.g., if X, then Y); save (i.e., save data to file in memory); emit sound; operate motor (run, stop, faster, slower, change torque, change gears, etc.); record image(s); program on or off time (one time or recurring); set brightness level; program conditional on/off (e.g., if garage door does not open, then turn on living room light at 6:15 pm); read/write commands (e.g., save estimated kW h consumption to file daily); other similar operations; or a combination thereof.

In some embodiments, systems of the invention include one or more of an LED lighting device installed (“local system”) and communicably coupled to a network as well as a program installed on a computer and communicably coupled over one or more of a network to the local system. A user controls aspects of the local system from the computer. The system controls illumination via LED apparatuses, and optionally turns on secondary apparatuses as-needed, such as, for example, turning on incandescent or fluorescent light fixtures upon failure of an LED apparatus; operating fan, heater, AC, or HVAC equipment depending on weather; opening or closing a door, window, or garage door; locking or unlocking a lock; or turning on/off an invisible fence. In certain embodiments, the computer is a laptop or PC and the program is an application. In certain embodiments, the computer is a smartphone (e.g., iPhone, Samsung Galaxy with Android, Blackberry, or similar) and the program is an app. As used herein, app generally refers to a program for a handheld device (e.g., with a touchscreen) and application generally refers to a program for a laptop or PC (e.g., with a keyboard and pointer).

For example, a user may download an app to a smartphone (or an application to a computer) and use it to control one or more LED lighting apparatuses that are installed in their home or business. By interacting with the app or application, the user may operate an LED lighting apparatus.

In some embodiments, the invention provides a mobile app for controlling the lighting devices from a smartphone. A user may download and install the mobile app onto their phone. To operate the an LED light of the invention, the user performs, for example, a touch-screen gesture within the mobile app. A signal is transmitted from the phone over a Wi-Fi or cellular RF network (or both), either directly to the light or to hardware that relays the signal to the light (e.g., over power lines), which operates responsive to the signal. Remote control instruction to lighting device can be received and acted on based on a pre-programmed schedule. For example, a person who owns several apartment buildings may sit at a computer in their office and schedule the on-times and off-times of a plurality of different LED lighting devices in different hallways, lobbies, and laundry rooms of different buildings. The user may use a dedicated computer program, or may schedule the lights through a plug in function in, for example, Microsoft OUTLOOK. As a result, the computer or a server computer can be used to execute computer program instructions which, at the selected times, transmit signals to the lights in the buildings causing them to turn on, turn off, brighten, or dim, according to the programmed schedule.

In certain aspects, the invention provides a safety system that includes an apparatus having a printed circuit board with at least one LED and a network connection. In some embodiments, the apparatus includes a very bright, highly visible LED and is configured to be off by default. Subject to certain conditions, the LED is turned on. For example, in some embodiments, the apparatus is included in a badge connected to a pet's collar. The apparatus includes a printed circuit board with a heat sink, at least one LED, a battery, a cellular RF antenna, and optionally a photovoltaic cell. The LED is off by default. The cellular RF antenna polls the cell network (e.g., exchanges a signal with a sector of an available cell tower) periodically (e.g., per hour, irregularly, per six hours, or per millisecond). The RF antenna in the apparatus transmits a query signal, which the tower relays to a system computer (e.g., server). The system computer responds by a sending an “all clear” signal which is relayed back to the apparatus. Upon receipt of the “all clear” signal, the apparatus does nothing (i.e., maintains a dark state, or off state). When a user (e.g., human) ascertains that their pet is lost, the user operates a computer program on a user computer to set a status setting to “lost”. If the system computer and the user computer are not the same, the user computer transmits the effective status setting (“lost”) to the system computer. After receipt of the “lost” effective status setting, upon receipt of the query signal from the collar apparatus, the system computer does not send an “all clear” signal. The computer instead sends either nothing or a lost signal. When the collar apparatus fails to receive an “all clear” signal, it triggers the LED, causing it to illuminate.

Due to the fact that the LED only remains dark if it successfully receives an “all clear” signal, the safety system has a built in failsafe in that, if the apparatus is out of range of any cell tower, the illumination will be triggered (i.e., the LED will be turned on). Under operation of the safety system, a pet may generally have a non-descript collar with a small apparatus connected (e.g., small plastic badge form factor). However, if the pet escapes a house, car, or leash, a person may trigger operation of the system, invoking significant two-fold safety protection. Due to the brightly lit LED, the pet will be easier to find, but will also be easier for a driver to see at night, thereby significantly decreasing the likelihood of accident and injury.

In certain embodiments, the printed circuit board includes a wireless communication device and optionally a microprocessor to enable operation of at least one LED on the board wireless. For example, by including a wireless connection, LED, heat sink, resistor, and optionally a processor in T12 replacement form factor, a bulb can be provided that can be programmed or operated remotely. A bulb can be turned on or off through use of an app on a smart phone. A bulb's present status (e.g., failure) can be received by a computer and saved to a file or accessed by a user. In some embodiments, the invention provides a system including a plurality of fluorescent replacement bulbs communicably coupled to a computing device. The status of the bulbs can be monitored by a central computer or the bulbs can be operated by the central computer. Use the system can offer building-wide or campus-wide lighting control or maintenance. An operator can control or monitor the lighting system throughout an entire building or campus from a single position at a computer.

Due to the fact that the wireless operation is provided within the fluorescent bulb form-factor, no retrofitting is required to an existing building structure or lighting fixture. An LED-based bulb replacement can include Wi-Fi, cell (e.g., 3G or 4G), or power line communication connections and can simply be put into fluorescent or other lighting fixtures throughout a building or campus. As offered by a provider (or custom-configurable), they will begin receiving commands or sending status over the wireless network to a computer device.

Due to the fact that the LED-based replacement bulbs include wireless communication or power balancing circuitry within, a user may switch existing light fixtures to low-power, computer controlled fixtures by only replacing the bulbs (i.e., without buying numerous additional components such as new fixtures, dimmers, timers, etc.). A user can replace existing bulbs with wireless enabled LED bulbs and install an app or application onto a computer device with a memory and a processor and the exert computer control over lighting. In a building-wide or campus-wide deployment, the system offers significant benefits in terms of lowered maintenance costs (e.g., due to the longevity inherent in LEDs as compared to traditional fluorescent fixtures) and significant benefits in terms of power savings (ability to turn unneeded lights off easily from a central location) and significant benefits in terms of security (can make any/ all buildings on campus or rooms in building appear occupied due to unpredictable on/off switching). Control of the system can be transferred from facilities maintenance to security or police on an as-needed basis. Computer controlled lighting systems allow control in a groups and permissions style. For example to illustrate, in a family household, children may be able to turn lights on and off, but a parent can override that control on an as-needed basis and turn all bedroom light off, or all yard lights on, for example. In, for example, a retirement home deployment, occupants can control lights in private rooms and common areas, but medical professionals can have overriding control abilities in an emergency.

In certain aspects, the invention provides a lighting apparatus that includes a printed circuit board with at least on LED light and an RF antenna and circuitry to control operation of the LED via communication through the RF antenna. The RF antenna may operate via communication with a computer device such as a smartphone. In various embodiments, operation of the LED via a computer device may be either direct or indirect (i.e., over a cell network). In indirect mode, the lighting apparatus receives commands through the antenna from a sector of a cell tower which communicates in-turn with a phone via a cell network.

In direct mode, the lighting apparatus communicates by sending and receiving RF signals between the RF antenna and an RF antenna within a mobile phone computing device. In this mode, the invention provides a light for which a phone operates as a remote control.

In some embodiments, a user is not aware of whether a system including the apparatus and the mobile phone is operating in direct or indirect mode. If the user is within the same area (e.g., within RF “reach”), the devices communicate directly. If the user is distal (e.g., other city or state), the devices communicate via a cell network. In some embodiments, the invention provides an app to be installed on the phone computer device. Operation of the lighting apparatus can be programmed via the app (i.e., on and off at certain times, etc.).

In further aspects of the invention, a lighting device may include a driver on the printed circuit board, in which the driver may utilize telemetry for additional functionality. The additional functionality may include advance warnings of failure of the system or the LEDs, details of the heat levels that are present in the system, or grid-shifting abilities. Grid shifting is discussed in U.S. Pub. 2012/0080944, the contents of which are incorporated by reference in their entirety. LED devices may include any radio or optic technology including wired or wireless, radio and network repeaters, integration of solar or other forms of electric generation, energy storage systems, provision for remote controlled adjustment of current or voltage, remote dimming, and the properties of semiconductor(s) junction for communication, the use of the LEDs themselves for communications, using optics as a sensory device, among other capabilities. The circuit board may utilize digital or analogue resistors to assist the system in regulating the current.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A lighting device comprising:
a printed circuit board;
a rectifier coupled to the circuit board; and
an insertion site on the circuit board for an LED.

2. The device of claim 1, further comprising an LED in the insertion site.

3. The device of claim 1, further comprising a fluorescent light bulb form factor.

4. The device of claim 1, further comprising a heat sink.

5. The device of claim 4, further comprising one selected from the list consisting of a dimmer, a timer, a receiver for remote control instructions, and a settable master/slave setting.

6. The device of claim 2, further comprising a receiver to receive control signals to control operation of the LED.

7. A lighting device comprising:
a printed circuit board;
a dimmer coupled to the circuit board; and
an insertion site on the circuit board for an LED.

8. The device of claim 7, further comprising a heat sink.

9. The device of claim 8, further comprising an LED in the insertion site.

10. The device of claim 9, further comprising a fluorescent light bulb form factor.

11. The device of claim 10, further comprising one selected from the list consisting of a rectifier, a timer, a receiver for remote control instructions, and a settable master/slave setting.

12. A lighting device comprising:
a printed circuit board;
a timer coupled to the circuit board; and
an insertion site on the circuit board for an LED.

13. A lighting device comprising:
a printed circuit board;
a receiver for remote control instructions coupled to the circuit board; and
an insertion site on the circuit board for an LED.

14. The lighting device of claim 13, further wherein the receiver comprises a Wi-Fi communication device.

15. The lighting device of claim 13, further wherein the receiver comprises an infrared communication device.

16. The lighting device of claim 13, further wherein the receiver comprises a cellular RF antenna.

17. The lighting device of claim 13, further wherein the receiver comprises a power line communication device.

18. The lighting device of claim 13, further wherein the receiver is a transceiver and further comprising a master/slave switch.

19. The device of claim 18, further wherein the receiver is adapted to, if the master/slave switch is in the slave setting, receive instructions from another lighting device and cause the lighting device to operate according to the instructions.

20. The device of claim 18, further comprising a microprocessor configured to, if the master/slave switch is in the master setting, transmit control signals via the transceiver.

21. A system for lighting space, the system comprising:
a plurality of lighting devices, each comprising an LED coupled to an insertion site on a printed circuit board and operably coupled to a receiver; and
a computing device comprising a processor coupled to a storage device and operable to initiate the transmission of signals that are then received by, and control the operation of, the plurality of lighting devices.

22. The system of claim 21, wherein the computing device communicates with the plurality of lighting devices through the use of a wireless communication technology.

23. The system of claim 21, wherein the computing device comprising a program application by which a user can pre-program the operation of the lighting devices.

24. The system of claim 21, wherein the control of the operation of the plurality of lighting devices includes the control of on/off state, the control of brightness, and the control of timing of on and off events.

25. The system of claim 21, further comprising at least one rectifier to modulate current received by at least one of the plurality of lighting devices.

26. The system of claim 21, further wherein at least one of the plurality of lighting devices comprises a fluorescent light bulb form factor.

27. The system of claim 21, wherein each of the plurality of lighting devices further comprises a heat sink.

28. The system of claim 21, further comprising a master lighting device, and further wherein each of the plurality of lighting devices is a slave lighting device, and further wherein each slave lighting device receives the signals from the master lighting device.

29. A method of changing illumination of a space, the method comprising:
using an electronic device comprising a memory coupled to a processor to transmit a signal to a lighting device, the lighting device comprising an LED and a receiver coupled to a printed circuit board;
receiving the signal with the receiver; and
changing an amount of light emitted from the LED based on data in the signal.

30. The method of claim 29, wherein the electronic device is a master lighting device comprising an LED, a controller, and a transmitter operably coupled to a master circuit board and configured to send the signal to the lighting device.

31. The method of claim 29, further wherein the electronic device is one selected from the list consisting of desktop computer, laptop computer, tablet computer, and smartphone.

32. The method of claim 29, further comprising rectifying current via a rectifier coupled to the circuit board.

33. The method of claim 29, wherein changing the amount of light emitted from the LED comprises gradually brightening and dimming the LED.

34. The method of claim 29, wherein changing the amount of light emitted from the LED comprises brightening and dimming the LED in a step-wise fashion.

35. The method of claim 29, wherein changing the amount of light emitted from the LED comprises turning the LED on or off on a pre-determined schedule.

36. The method of claim 29, further comprising transmitting signals to a plurality of lighting devices.

37. The method of claim 36, wherein the plurality of lighting devices are distributed among a plurality of buildings on a campus.

38. The method of claim 37, wherein the electronic device comprises a monitor and keyboard.

39. The method of claim 29, wherein changing the amount of light emitted from the LED comprises changing the amperage that is delivered to the LED.

40. The method of claim 29, wherein changing the amount of light emitted from the LED comprises using a potentiometer.

41. The method of claim 29, wherein changing the amount of light emitted from the LED comprises pulse width modulation.

42. The method of claim 29, wherein the receiver comprises a Wi-Fi antenna.

43. The method of claim 29, wherein the receiver comprises an infrared receiver.

44. The method of claim 29, wherein the receiver comprises a cellular RF antenna.

45. The method of claim 29, wherein the receiver comprises a power line communication device.
